(19) United States
(12) Patent Application Publication
(10) Pub. No.: US 2022/0080524 A1
(43) Pub. Date: Mar. 17, 2022

(54) SYSTEMS AND METHODS FOR ALIGNING LASERS USING SENSOR DATA

(71) Applicant: Ohio State Innovation Foundation, Columbus, OH (US)

(72) Inventor: Jacob Rindler, Columbus, OH (US)

(21) Appl. No.: 17/478,009

(22) Filed: Sep. 17, 2021

Related U.S. Application Data
(60) Provisional application No. 63/079,539, filed on Sep. 17, 2020.

(51) Int. Cl. B23K 26/035; B29C 64/153; B23K 26/12; B23K 26/042

(52) U.S. Cl. CPC B23K 26/035; B29C 64/153; B33Y 30/00; B23K 26/042; B23K 26/125

(57) ABSTRACT

In an additive manufacturing machine using a plurality of lasers, a reference laser is established that remains stationary and focused on a commanded point in a collection area. The reference laser uses one or more co-axial sensors to monitor emitted electromagnetic energy in the area. While the reference laser is monitoring the area, each non-reference laser in turn produces and moves a meltpool through the collection area in a known movement. For each non-reference laser, the electromagnetic energy collected and observed by the reference laser during positions of the known movement is compared with an expected electromagnetic energy for each position. For a given non-reference laser, the differences between the observed and expected electromagnetic energies can be used to determine differences between a coordinate system of the reference laser and a coordinate system of non-reference laser. The non-reference laser may then be realigned based on the determined differences.

### CROSS-REFERENCE TO RELATED APPLICATIONS

This application claims the benefit of U.S. provisional patent application No. 63/079,539, filed on Sep. 17, 2020, and entitled “METHOD FOR ALIGNING MULTIPLE LASERS USING AXIAL SENSOR DATA,” the disclosure of which is expressly incorporated herein by reference in its entirety.

### BACKGROUND

Additive manufacturing, also known as 3D printing, is a growing industry. In additive manufacturing, three-dimensional objects are created one layer at a time, where each successive layer of material bonds to a preceding layer of previously melted material. In order to melt the material, a laser may be used.

In order to scale additive manufacturing, and increase the speed of production, multiple lasers may be used to create a single object. However, keeping multiple laser aligned is difficult, and laser misalignment may result in sloppy or incorrectly printed objects.

It is with respect to these and other considerations that the various aspects and embodiments of the present disclosure are presented.

### SUMMARY

In an additive manufacturing machine using a plurality of lasers, one or more reference lasers may be established. The reference laser uses one or more co-axial sensors to monitor emitted electromagnetic energy from a given field of view known as a collection area. While the reference laser's co-axial sensor(s) are monitoring its collection area, an additional laser(s) besides the reference laser (i.e., non-reference lasers) in turn produces moves a meltpool or irradiated zone through the collection area in a set of known movements. For each non-reference laser, the electromagnetic energy collected and observed by the reference laser during positions of the known movement is compared with an expected electromagnetic energy for each position. For a given non-reference laser, the differences between the observed and expected electromagnetic energies can be used to determine differences between a coordinate system of the reference laser and a coordinate system of non-reference laser. The non-reference laser may then be aligned based on the determined differences.

In an embodiment, a method is provided. The method includes: establishing a reference laser with a known position in a collection area; establishing a non-reference laser; causing the reference laser to measure electromagnetic radiation in the collection area; while the reference laser measures electromagnetic radiation in the collection area, causing the non-reference laser to move an electromagnetic excitation through a set of known movements in the collection area; based on the measured electromagnetic radiation during each known movement, determining a misalignment between the reference laser and the non-reference laser; and aligning the non-reference laser with the reference laser based on the determined misalignment.

Embodiments may have some or all of the following features. The reference laser may measure electromagnetic radiation using a co-axial sensor. The co-axial sensor may include at least two co-axial sensors. The electromagnetic excitation may include a meltpool. The set of known movements may be a set of parallel lines. Causing the reference laser to measure electromagnetic radiation in the collection area may include causing the reference laser to measure electromagnetic radiation in the collection area at each time of a plurality of times. The method may further include: receiving a position of the electromagnetic excitation in the collection area for each time of the plurality of times; and based on the measured electromagnetic radiation at each time and the received position of the electromagnetic excitation at each time, determining the misalignment between the reference laser and the non-reference laser. The method may further include: determining a peak electromagnetic excitation measured by the reference laser; determining a time associated with the peak electromagnetic excitation; determining the received position of the electromagnetic excitation at the determined time; determining a difference between the known position in the collection area and the received position of the electromagnetic excitation in the collection area; and determining the misalignment between the reference laser and the non-reference laser based on the determined difference. Establishing the non-reference laser may include establishing a plurality of non-reference lasers. Aligning the non-reference laser with the reference laser based on the determined misalignment may include determining an offset for the non-reference laser.

In an embodiment, a system is provided. The system may include a reference laser with a known position in a collection area; a non-reference laser; and a computing device. The non-reference laser is adapted to move an electromagnetic excitation through a set of known movements in the collection area. The reference laser is adapted to measure electromagnetic radiation in the collection area while the non-reference laser moves the electromagnetic excitation through the set of known movements in the collection area. The computing device is adapted to: receive the measured electromagnetic radiation for each known movement in the set of known movements; and based on the measured electromagnetic radiation during each known movement in the set of known movements, determine a misalignment between the reference laser and the non-reference laser.

Embodiments may include some or all of the following features. The computing device may be further adapted to align the reference laser and the non-reference laser based on the determined misalignment. The computing device may be further adapted to determine an offset for the non-reference laser based on the determined misalignment. The reference laser may measure electromagnetic radiation using a co-axial sensor. The co-axial sensor may include at least two co-axial sensors. The electromagnetic excitation may include a meltpool. The set of known movements may be a set of parallel lines. The reference laser adapted to measure electromagnetic radiation in the collection area may include the reference laser adapted to measure electromagnetic radiation in the collection area at each time of a plurality of times. The computing device may be further adapted to: receive the measured electromagnetic radiation in the collection area at each time of a plurality of times; receive a position of the electromagnetic excitation in the collection area for each time of the plurality of times from the non-reference laser; and based on the measured electromagnetic radiation at each time and the received position of the electromagnetic excitation at each time, determine the misalignment between the reference laser and the non-reference laser. The computing device may be further adapted to: determine a peak electromagnetic excitation measured by the reference laser; determine a time associated with the peak electromagnetic excitation; determine the received position of the electromagnetic excitation in the collection area at the determined time; determine a difference between the known position in the collection area and the received position of the electromagnetic excitation in the collection area; and determine the misalignment between the reference laser and the non-reference laser based on the determined difference.

This summary is provided to introduce a selection of concepts in a simplified form that are further described below in the detailed description. This summary is not intended to identify key features or essential features of the claimed subject matter, nor is it intended to be used to limit the scope of the claimed subject matter.

### BRIEF DESCRIPTION OF THE DRAWINGS

The foregoing summary, as well as the following detailed description of illustrative embodiments, is better understood when read in conjunction with the appended drawings. For the purpose of illustrating the embodiments, there is shown in the drawings example constructions of the embodiments; however, the embodiments are not limited to the specific methods and instrumentalities disclosed. In the drawings:

FIG. 1 is an illustration of an example environment for aligning lasers;

FIG. 2 is an illustration of an example collection area;

FIG. 3 is an illustration of a graph of signal intensity versus time;

FIG. 4 is an illustration of an example method for aligning one or more lasers;

FIG. 5 is an illustration of an example for determining the misalignment of a laser based on peak radiation measurements; and

FIG. 6 shows an exemplary computing environment in which example embodiments and aspects may be implemented.

### DETAILED DESCRIPTION

This description provides examples not intended to limit the scope of the appended claims. The figures generally indicate the features of the examples, where it is understood and appreciated that like reference numerals are used to refer to like elements. Reference in the specification to “one embodiment” or “an embodiment” or “an example embodiment” means that a particular feature, structure, or characteristic described is included in at least one embodiment described herein and does not imply that the feature, structure, or characteristic is present in all embodiments described herein.

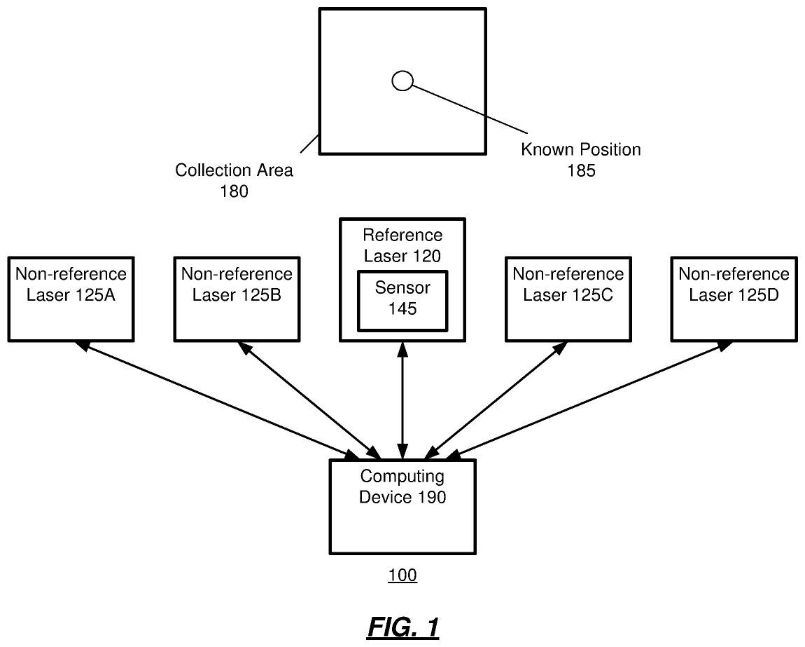

FIG. 1 is an illustration of an example environment 100 for aligning lasers. As shown the environment 100 may include a plurality of non-reference lasers 125 (e.g., the non-reference lasers 125A, 125B, 125C, and 125D), a reference laser 120, and a computing device 190. The lasers 120 and 125, and the computing device 190 may be part of an additive manufacturing machine, and the non-reference lasers 125 may be controlled by the computing device 190 or a different control/computing device in order to create one or more three-dimensional objects. While only four non-reference lasers are shown, it is for illustrative purposes only. There is no limit to the number of non-reference lasers 125 that may be supported by the environment 100.

As described above, one drawback associated with the use of multiple lasers 125 is that the lasers may become misaligned. In some embodiments, a first laser 125 is said to be misaligned with a second laser 125 when the coordinate systems used by each of the first laser 125 and the second laser 125 are not aligned. When the coordinate systems of two lasers 125 are misaligned, they can no longer be used by the additive manufacturing machine to operate on the same three-dimensional object while ensuring proper quality.

Accordingly, in order to realign the lasers 125, the environment 100 may include the reference laser 120. The reference laser 120 may be stationary and may be focused on a known position 185 in a collection area 180. The known position 185 may have a known location within the collection area 180 such as the center. However, other locations in the collection area 180 may be used.

The reference laser 120 may further include one or more sensors 145. The one or more sensors 145 may be co-axial sensors and may measure electromagnetic radiation in the collection area 180. Depending on the embodiment, the measured electromagnetic radiation may include frequencies known to be emitted by the non-reference lasers 125.

During an alignment procedure, the computing device 190 may instruct each non-reference laser 125 to move an excitation area in the collection area according to a set of known movements. The set of known movements may be a pattern or series of positions that the non-reference laser 125 is instructed to move the excitation area within the collection area. Depending on the embodiment, the excitation area may be a meltpool.

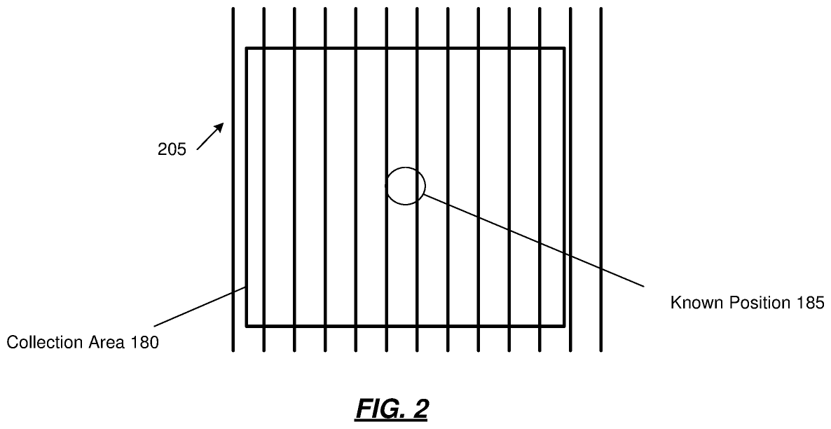

For example, continuing to FIG. 2 is an illustration of an example set of known movements 205 that a non-reference laser 125 may move the excitation area within the collection area 180. As shown, the set of movements 205 consists of multiple evenly spaced parallel lines. Other patterns may be used. Each non-reference laser 125 may use the same set of movements 205 in the collection area 180. Alternatively, some non-reference lasers 125 may use different sets of movements 205. The particular movements 205 used by each laser 125 may be selected by a user or administrator.

Returning to FIG. 1, while a non-reference laser 125 moves its excitation area through the collection area 180, the sensors 145 of the reference laser 120 may begin measuring the electromagnetic radiation within the collection area 180 at or around the known position 185 for each time of a set of times. In addition, the non-reference laser 125 may record its position in the collection area 180 for each time of the set of times as it moves through the movements 205.

After a non-reference laser 125 completes the movements 205, the non-reference laser 125 may send its recorded positions at each time to the computing device 190. In addition, the reference laser 120 may send its measured electromagnetic radiation at each time. Based on the positions reported by the non-reference laser 125 and the measured electromagnetic radiation, the computing device 190 may determine whether there is a misalignment between the reference laser 120 and the non-reference laser 125.

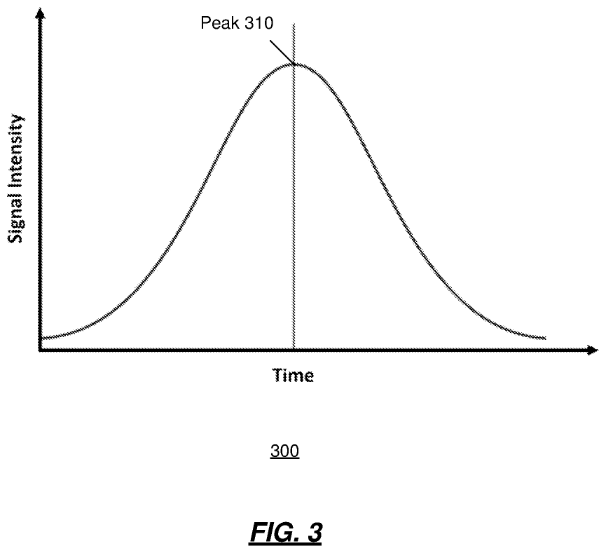

In some embodiments, the computing device 190 may determine whether there is a misalignment based on a peak measured electromagnetic radiation. Continuing to FIG. 3 is an illustration of a graph 300 of signal intensity (i.e., measured electromagnetic radiation by the sensor 145) versus time. As may be appreciated, the peak 310 electromagnetic radiation measured by the sensor 145 should be when the center of the excitation area of the non-reference laser 125 is closest to the known point 185 within the collection area 180. Accordingly, the position of the non-reference laser 125 reported at the time when the peak 310 is measured may be used to determine if the non-reference laser 125 and the reference laser 120 are misaligned.

When it is determined that a non-reference laser 125 and the reference laser 120 are misaligned, the computing device 190 may realign the non-reference laser 125 and the reference laser 120. In some embodiments, the computing device 190 may realign the non-reference laser 125 and the reference laser 120 by calculating an offset. The calculated offset may be a set of values that may be added to the coordinates of the non-reference laser 125 such that the coordinate systems used by the non-reference laser 125 and the reference laser 120 are aligned. The values of the offset may include an x offset, a y offset, and an angular offset. The values of the offset may be calculated by the computing device 190 comparing the measured electromagnetic radiation during the movement at each time with the position reported by the non-reference laser 125 at each time.

As may be appreciated, at some point, the reference laser 120 and a non-reference laser 125 may become so misaligned that the misalignment cannot be corrected using an offset. In such scenarios, the computing device 190 may instruct an administrator or technician to realign the non-reference laser 125.

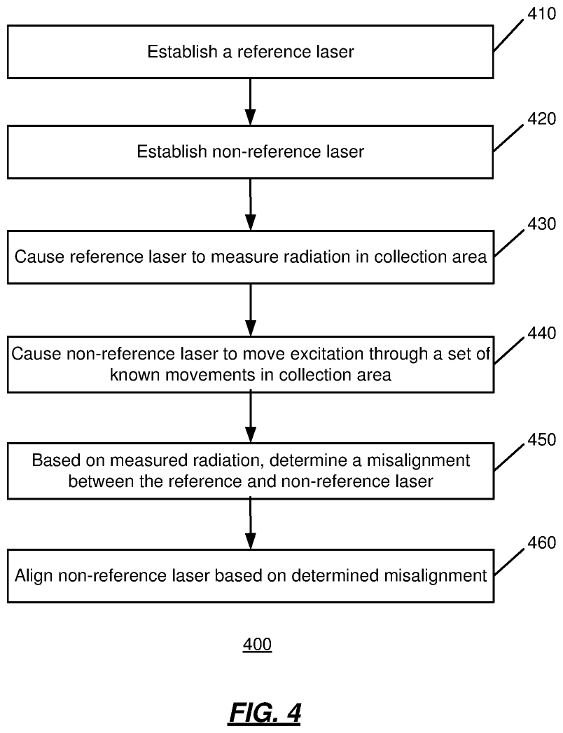

FIG. 4 is an illustration of an example method 400 for aligning one or more lasers. The method 400 may be performed in part by the computing device 190.

At 410, a reference laser is established. The reference laser 120 may be part of an additive manufacturing device. The reference laser 120 may include one or more sensors 145 such as coaxial sensors. The reference laser 120 may be focused on a known position 185 within a collection area 180.

At 420, a non-reference laser is established. The non-reference laser 125 may be one of multiple non-reference lasers 125 (e.g., two or more) that are part of the additive manufacturing device. The non-reference laser 125 may be used as part of the additive manufacturing process.

At 430, the reference laser is caused to measure electromagnetic radiation in the collection area. The reference laser 120 may be caused to measure electromagnetic radiation using the sensor 145 by the computing device 190. In some embodiments, the reference laser 120 may take a measurement of the electromagnetic radiation repeatedly during a set of times associated with a calibration process.

At 440, the non-reference laser is caused to move an electromagnetic excitation through a set of known movements in the collection area. The non-reference laser may be caused to move the electromagnetic excitation by the computing device 190 during the calibration process while the reference laser 120 measures the electromagnetic radiation. The electromagnetic excitation may be a meltpool. The set of known movements may be parallel lines in the collection area 180.

At 450, based on the measured radiation, a misalignment between the reference laser and the non-reference laser is determined. The misalignment may be determined by the computing device 190. In some embodiments, the misalignment may be determined by comparing the measured electromagnetic radiation at each time with the expected electromagnetic radiation for the time based on the supposed location of the excitation in the collection area 180 according to the known movements. Alternatively, or additionally, the non-reference laser 125 may provide the position of the excitation in the collection area. The position may be based on the coordinate system of the non-reference laser 125 and may not match the coordinate system of the reference laser 120 depending on the misalignment.

At 460, the non-reference laser is aligned with the reference laser based on the determined misalignment. The non-reference laser 125 may be aligned with the reference laser 120 by the computing system 190. In some embodiments, the computing system 190 may generate an offset that may be used to align the non-reference laser 125 with the reference laser 120. For example, the offset may be added to coordinates provided to the non-reference laser 125 by the computing device 190 during the additive manufacturing process.

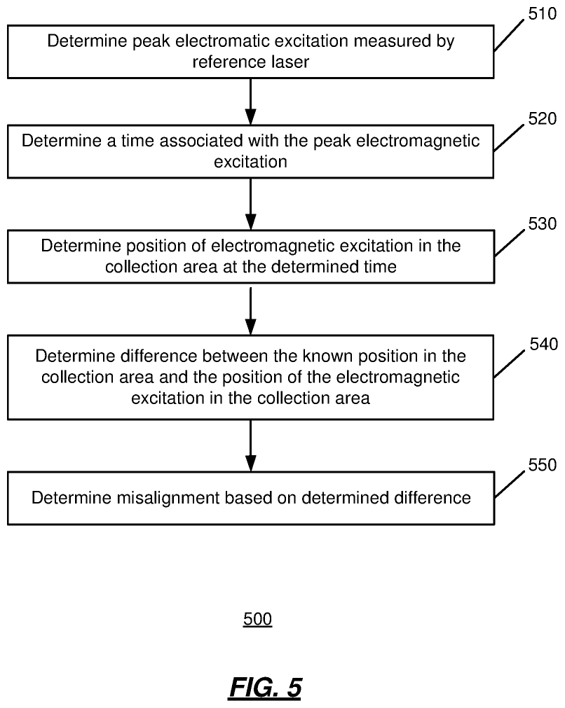

FIG. 5 is an illustration of an example method 500 for determining the misalignment of a laser based on peak radiation measurements. The method 500 may be performed in part by the computing device 190.

At 510, a peak electromagnetic excitation measured by the reference laser is determined. The peak electromagnetic excitation may be determined by the computing device 190 from the measurements collected by the sensor 145 during one or more known movements of the electromagnetic excitation through the collection area 180 by the non-reference laser 125. Each measured excitation may be associated with a time when the excitation was measured.

At 520, a time associated with the peak excitation is determined. The time may be determined by the computing device 190 based on information provided by the sensor 145.

At 530, a position of the electromagnetic excitation in the collection area is determined. The position may be determined by the computing device 190. The position may be the position in the collection area 180 where the electromagnetic excitation should have been at the determined time had the non-reference laser 120 be properly calibrated or using the same coordinate system as the reference laser 120. In some embodiments, the position at the determined time may be provided by the reference laser 125. Alternatively, the position may be determined from the time based on the movements in the set of movements that the non-reference laser 125 was following when moving the electromagnetic excitation in the collection area 180.

At 540, a difference between the known position in the collection area and the position of the electromagnetic excitation in the collection area is determined. The difference may be determined by the computing device 190.

At 550, a misalignment is determined. The misalignment may be determined by the computing device 190 based on the difference between the known position in the collection area and the position of the electromagnetic excitation in the collection area. Because the position associated with the highest measured or peak electromagnetic excitation should be the known position 185, any difference between the position of the electromagnetic excitation in the collection area and the known position 185 may indicate a misalignment. The greater the difference, the greater the misalignment between the non-reference laser 125 and the reference laser 120.

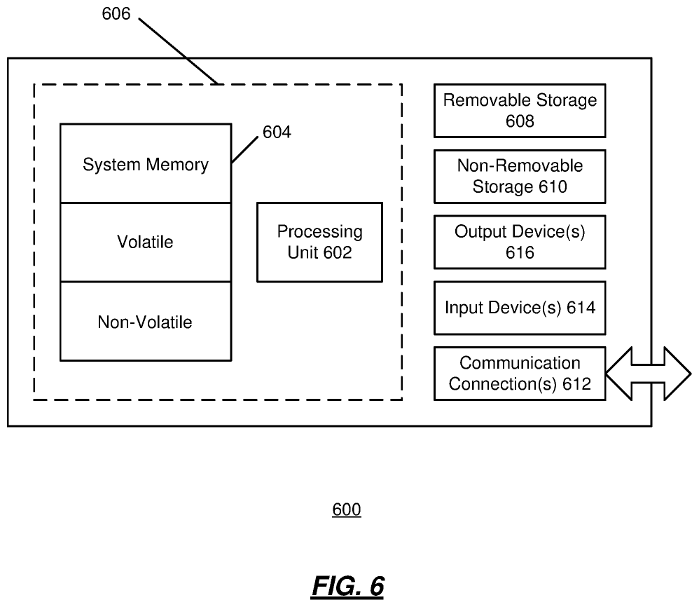

FIG. 6 shows an exemplary computing environment in which example embodiments and aspects may be implemented. The computing device environment is only one example of a suitable computing environment and is not intended to suggest any limitation as to the scope of use or functionality.

Numerous other general purpose or special purpose computing devices environments or configurations may be used. Examples of well-known computing devices, environments, and/or configurations that may be suitable for use include, but are not limited to, personal computers, server computers, handheld or laptop devices, multiprocessor systems, microprocessor-based systems, network personal computers (PCs), minicomputers, mainframe computers, embedded systems, distributed computing environments that include any of the above systems or devices, and the like.

Computer-executable instructions, such as program modules, being executed by a computer may be used. Generally, program modules include routines, programs, objects, components, data structures, etc. that perform particular tasks or implement particular abstract data types. Distributed computing environments may be used where tasks are performed by remote processing devices that are linked through a communications network or other data transmission medium. In a distributed computing environment, program modules and other data may be located in both local and remote computer storage media including memory storage devices.

With reference to FIG. 6, an exemplary system for implementing aspects described herein includes a computing device, such as computing device 600. In its most basic configuration, computing device 600 typically includes at least one processing unit 602 and memory 604. Depending on the exact configuration and type of computing device, memory 604 may be volatile (such as random access memory (RAM)), non-volatile (such as read-only memory (ROM), flash memory, etc.), or some combination of the two. This most basic configuration is illustrated in FIG. 6 by dashed line 606.

Computing device 600 may have additional features/functionality. For example, computing device 600 may include additional storage (removable and/or non-removable) including, but not limited to, magnetic or optical disks or tape. Such additional storage is illustrated in FIG. 6 by removable storage 608 and non-removable storage 610.

Computing device 600 typically includes a variety of computer readable media. Computer readable media can be any available media that can be accessed by the device 600 and includes both volatile and non-volatile media, removable and non-removable media.

Computer storage media include volatile and non-volatile, and removable and non-removable media implemented in any method or technology for storage of information such as computer readable instructions, data structures, program modules or other data. Memory 604, removable storage 608, and non-removable storage 610 are all examples of computer storage media. Computer storage media include, but are not limited to, RAM, ROM, electrically erasable program read-only memory (EEPROM), flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by computing device 600. Any such computer storage media may be part of computing device 600.

Computing device 600 may contain communication connection(s) 612 that allow the device to communicate with other devices. Computing device 600 may also have input device(s) 614 such as a keyboard, mouse, pen, voice input device, touch input device, etc. Output device(s) 616 such as a display, speakers, printer, etc. may also be included. All these devices are well known in the art and need not be discussed at length here.

It should be understood that the various techniques described herein may be implemented in connection with hardware components or software components or, where appropriate, with a combination of both. Illustrative types of hardware components that can be used include Field-programmable Gate Arrays (FPGAs), Application-specific Integrated Circuits (ASICs), Application-specific Standard Products (ASSPs), System-on-a-chip systems (SOCs), Complex Programmable Logic Devices (CPLDs), etc. The methods and apparatus of the presently disclosed subject matter, or certain aspects or portions thereof, may take the form of program code (i.e., instructions) embodied in tangible media, such as floppy diskettes, CD-ROMs, hard drives, or any other machine-readable storage medium where, when the program code is loaded into and executed by a machine, such as a computer, the machine becomes an apparatus for practicing the presently disclosed subject matter.

Although exemplary implementations may refer to utilizing aspects of the presently disclosed subject matter in the context of one or more stand-alone computer systems, the subject matter is not so limited, but rather may be implemented in connection with any computing environment, such as a network or distributed computing environment. Still further, aspects of the presently disclosed subject matter may be implemented in or across a plurality of processing chips or devices, and storage may similarly be effected across a plurality of devices. Such devices might include personal computers, network servers, and handheld devices, for example.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed:

1. A method comprising:
establishing a reference laser with a known position in a collection area;
establishing a non-reference laser;
causing the reference laser to measure electromagnetic radiation in the collection area;
while the reference laser measures electromagnetic radiation in the collection area, causing the non-reference laser to move an electromagnetic excitation through a set of known movements in the collection area;
based on the measured electromagnetic radiation during each known movement, determining a misalignment between the reference laser and the non-reference laser; and
aligning the non-reference laser with the reference laser based on the determined misalignment.

2. The method of claim 1, wherein the reference laser measures electromagnetic radiation using a co-axial sensor.

3. The method of claim 2, wherein the co-axial sensor comprises at least two co-axial sensors.

4. The method of claim 1, wherein the electromagnetic excitation comprises a meltpool.

5. The method of claim 1, wherein the set of known movements is a set of parallel lines.

6. The method of claim 1, wherein causing the reference laser to measure electromagnetic radiation in the collection area comprises:
causing the reference laser to measure electromagnetic radiation in the collection area at each time of a plurality of times.

7. The method of claim 6, further comprising:
receiving a position of the electromagnetic excitation in the collection area for each time of the plurality of times; and
based on the measured electromagnetic radiation at each time and the received position of the electromagnetic excitation at each time, determining the misalignment between the reference laser and the non-reference laser.

8. The method of claim 6, further comprising:
determining a peak electromagnetic excitation measured by the reference laser;
determining a time associated with the peak electromagnetic excitation;
determining the received position of the electromagnetic excitation at the determined time;
determining a difference between the known position in the collection area and the received position of the electromagnetic excitation in the collection area; and
determining the misalignment between the reference laser and the non-reference laser based on the determined difference.

9. The method of claim 1, wherein establishing the non reference laser comprises establishing a plurality of non-reference lasers.

10. The method of claim 1, wherein aligning the non-reference laser with the reference laser based on the determined misalignment comprises determining an offset for the non-reference laser.

11. A system comprising:
a reference laser with a known position in a collection area;
a non-reference laser; and
a computing device, wherein the non-reference laser is adapted to move an electromagnetic excitation through a set of known movements in the collection area, wherein the reference laser is adapted to measure electromagnetic radiation in the collection area while the non-reference laser moves the electromagnetic excitation through the set of known movements in the collection area, and further wherein the computing device is adapted to:
receive the measured electromagnetic radiation for each known movement in the set of known movements; and
based on the measured electromagnetic radiation during each known movement in the set of known movements, determine a misalignment between the reference laser and the non-reference laser.

12. The system of claim 11, wherein the computing device is further adapted to align the reference laser and the non-reference laser based on the determined misalignment.

13. The system of claim 12, wherein the computing device is further adapted to determine an offset for the non-reference laser based on the determined misalignment.

14. The system of claim 11, wherein the reference laser measures electromagnetic radiation using a co-axial sensor.

15. The system of claim 14, wherein the co-axial sensor comprises at least two co-axial sensors.

16. The system of claim 11, wherein the electromagnetic excitation comprises a meltpool.

17. The system of claim 11, wherein the set of known movements is a set of parallel lines.

18. The system of claim 11, wherein the reference laser adapted to measure electromagnetic radiation in the collection area comprises the reference laser adapted to measure electromagnetic radiation in the collection area at each time of a plurality of times.

19. The system of claim 18, wherein the computing device is further adapted to:
receive the measured electromagnetic radiation in the collection area at each time of a plurality of times;
receive a position of the electromagnetic excitation in the collection area for each time of the plurality of times from the non-reference laser; and
based on the measured electromagnetic radiation at each time and the received position of the electromagnetic excitation at each time, determine the misalignment between the reference laser and the non-reference laser.

20. The system of claim 19, wherein the computing device is further adapted to:
determine a peak electromagnetic excitation measured by the reference laser;
determine a time associated with the peak electromagnetic excitation;
determine the received position of the electromagnetic excitation in the collection area at the determined time:
determine a difference between the known position in the collection area and the received position of the electromagnetic excitation in the collection area; and
determine the misalignment between the reference laser and the non-reference laser based on the determined difference.
